(19) United States
(12) Patent Application Publication
(10) Pub. No.: US 2015/0129568 A1
(43) Pub. Date: May 14, 2015

(54) WELDING CART

(71) Applicant: LINCOLN GLOBAL, INC., City of Industry, CA (US)

(72) Inventor: VICTOR MILLER, JAMUL, CA (US)

(73) Assignee: LINCOLN GLOBAL, INC., City of Industry, CA (US)

(21) Appl. No.: 14/174,903

(22) Filed: Feb. 7, 2014

Related U.S. Application Data
(60) Provisional application No. 61/903,218, filed on Nov. 12, 2013.

(51) Int. Cl. B23K 37/02

(52) U.S. Cl. CPC B23K 37/0294
USPC 219/137.2

(57) ABSTRACT

The present invention generally provides a welding cart including a frame including a base and at least one support extending over from the base; a mount supported on the support, the mount having a mounting surface on which a wire feeder is supported, the mounting surface is being configured to raise a first end of the wire feeder to support to the wire feeder at an angle, where the wire conduit extending from the wire feeder extends from a lower end of the wire feeder. According to another embodiment of the invention, the mount has a slopped mounting surface adapted to support a wire feeder.

This application claims priority to and the benefit of U.S. Provisional Patent Application 61/903,218, filed on Nov. 12, 2013.

### TECHNICAL FIELD

The present invention generally relates to a cart used to transport welding components. More particularly, the present invention relates to a cart having a wire feeder mount that angles the wire feeder downward.

### BACKGROUND OF THE INVENTION

Welding components including but not limited to wire feeders, power supplies, and welding process controllers are often mounted on a cart so that they may be moved as a unit or to make heavier components portable by providing them on a cart that may be rolled on wheels or transported by a fork lift, crane, or other operation. These carts typically include a horizontal shelf on which one or more components is mounted. It is noted that when mounting a wire feeder on a horizontal shelf, the wire feeder cable tends to drape at an angle of about 90° to extend downward from the shelf. The cable, which may also be referred to as a wire conduit, connects to the torch to supply welding wire to the welding application. It will be appreciated that the tighter the angle that the wire has to travel through increases the resistance to movement of the wire within the conduit, increases wear between the wire and the conduit, and can deform the wire. Therefore, it is desirable to mount the wire feeder on the cart in a manner that increases the angle formed by the conduit as it extends from the cart.

### SUMMARY OF THE INVENTION

The present invention generally provides a welding cart including a frame; a mount supported on the frame, the mount having a mounting surface on which a wire feeder is supported, the mounting surface being configured to raise a first end of the wire feeder to support the wire feeder at an angle, where the wire conduit extending from the wire feeder extends from a lower end of the wire feeder. According to another embodiment of the invention, the mount has a sloped mounting surface adapted to support a wire feeder.

The present invention further provides a welding cart including a frame having a base, plural supports extending upward from the base and a mounting platform supported on the supports and spaced upward from the base; a mounting surface extending above the mounting platform and adapted to support a wire feeder thereon, the mounting surface extending outward as it extends forward to support the wire feeder at an angle, where a wire feeder conduit extends from a lower end of the wire feeder and wherein the conduit drapes downward from the wire feeder at an angle greater than 90°.

The present invention further provides a welding cart comprising a frame having a base adapted to support one or more welding components; and an under carriage including a pair of channel members extending downward from the base, the channel members each defining a channel adapted to receive a tine of a fork lift. According to another aspect of the invention, the base includes plural casters extending downward therefrom and below the channel members to define a clearance between a lower surface of the under carriage assembly and the bottom of the casters wherein the clearance is less than 4 inches. According to another aspect of the invention, the channels extend longitudinally along the base and are spaced inward from the casters.

### BRIEF DESCRIPTION OF THE DRAWINGS

FIG. 1 is a perspective view of a welding cart according to the concepts of the present invention having plural welding components supported thereon.

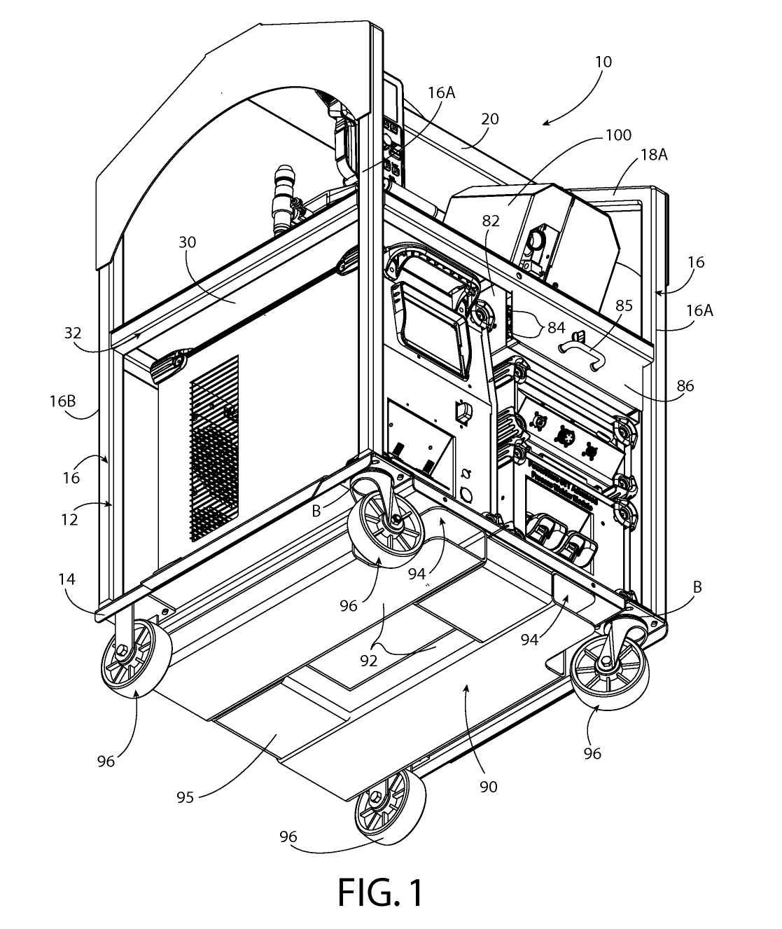

FIG. 2 is a front elevational view thereof.

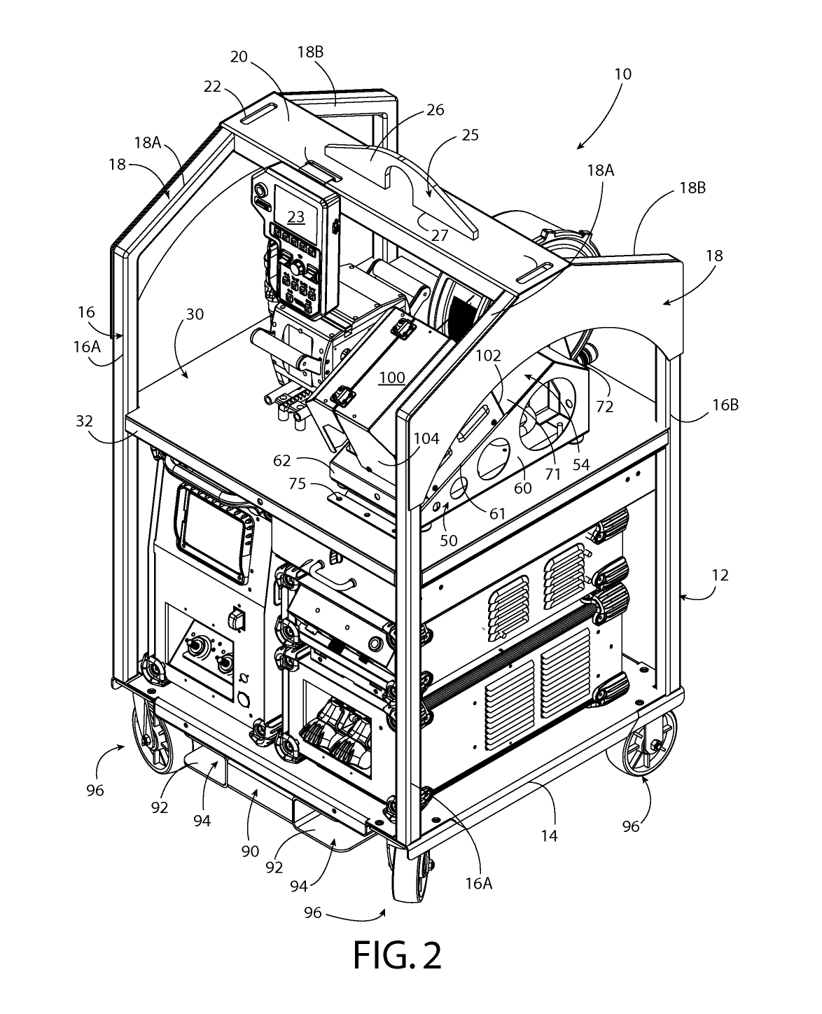

FIG. 3 is a rear elevational view thereof

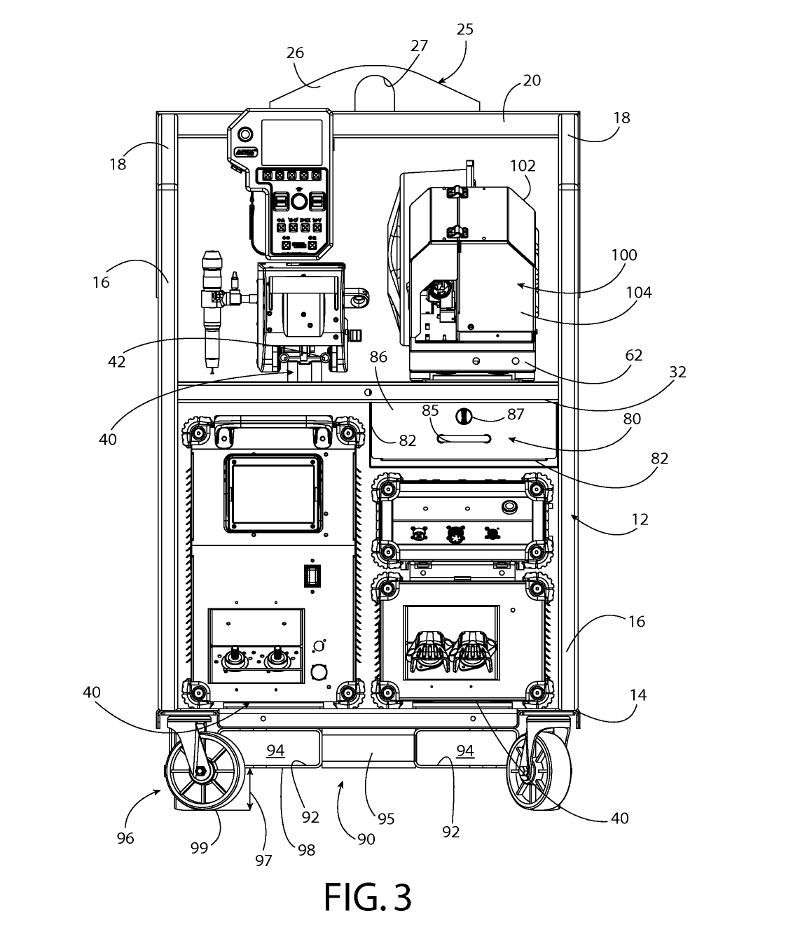

FIG. 4 is a top plan view thereof.

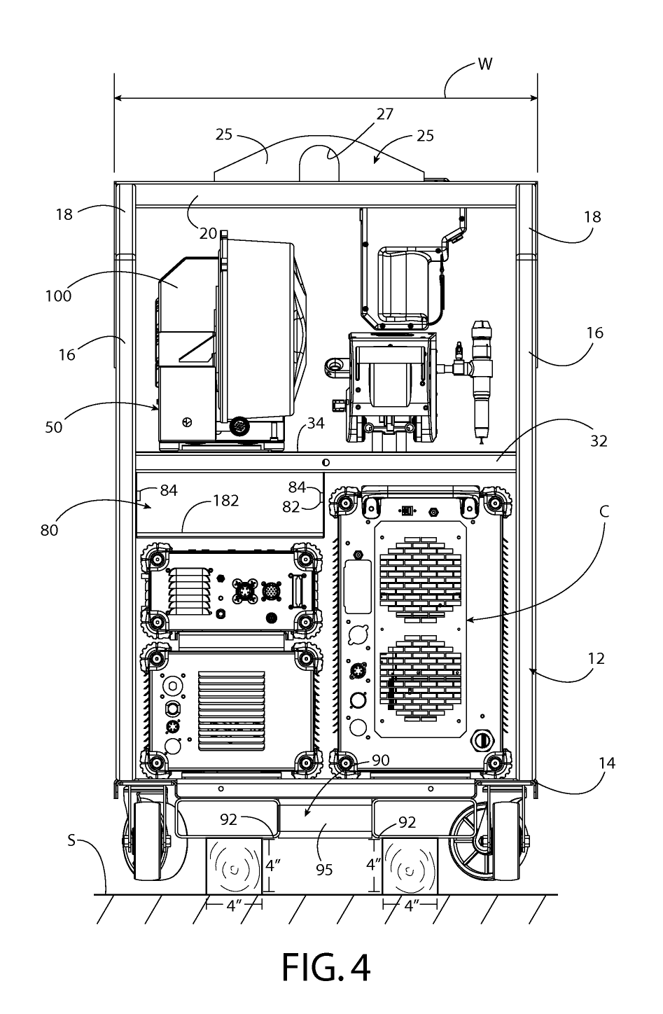

FIG. 5 is a bottom plan view thereof.

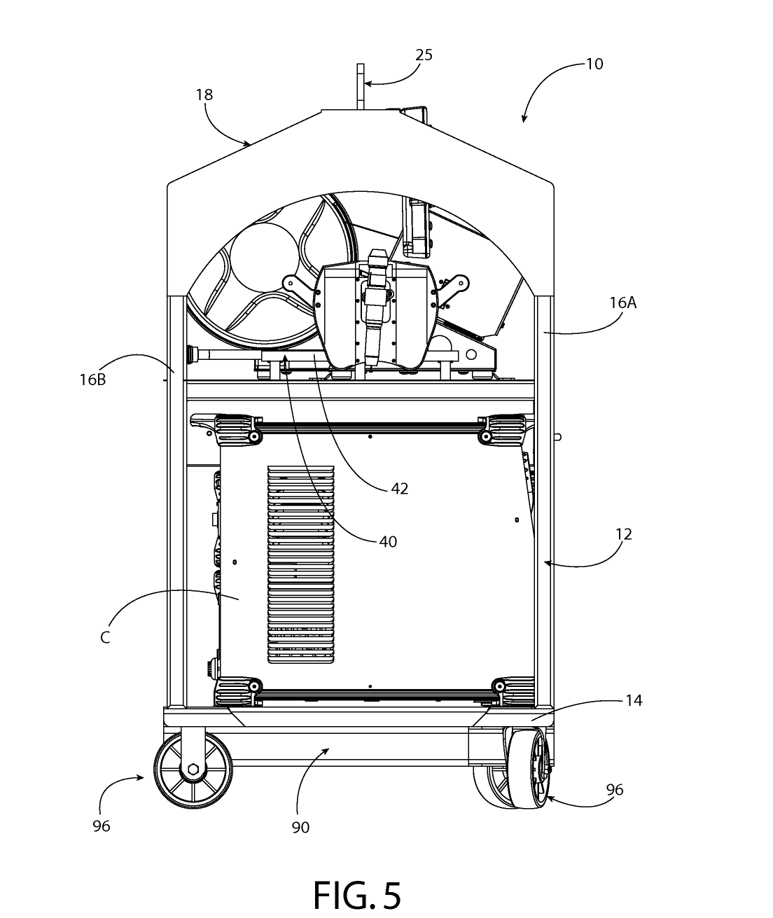

FIG. 6 is a left side elevational view thereof.

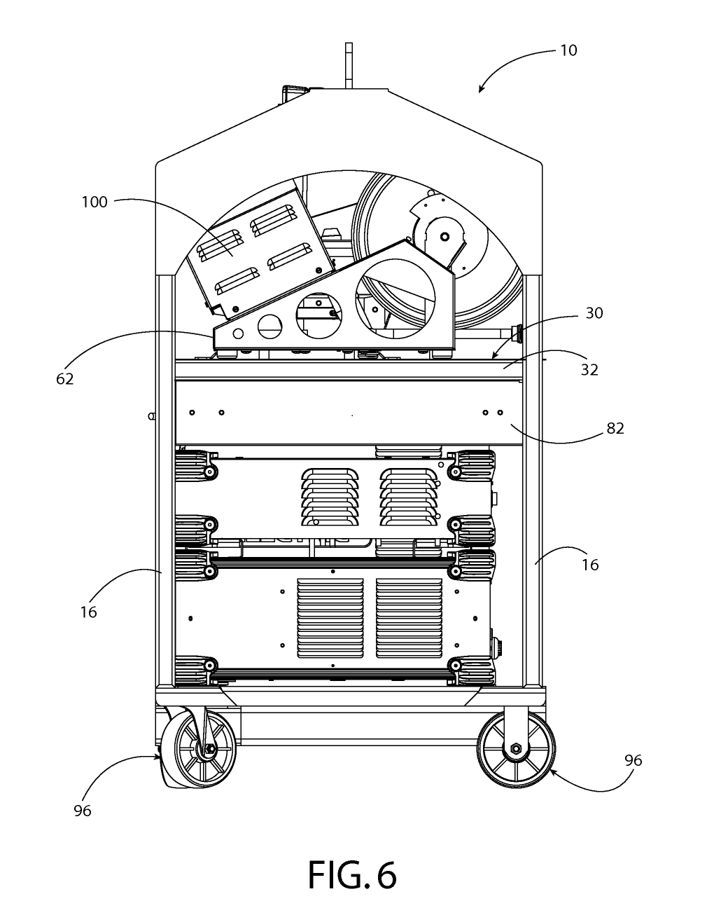

FIG. 7 is a right side elevational view thereof.

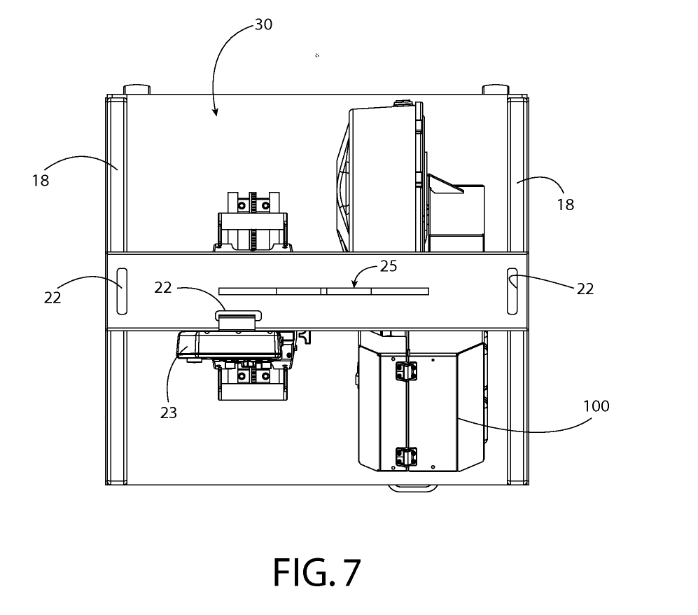

FIG. 8 is a top perspective view thereof.

FIG. 9 is a perspective view similar to FIG. 8 with all of the components removed to show further details of the component attachment assemblies.

FIG. 10 is an enlarged right side elevational view showing details of the wire feeder support bracket.

FIG. 11 is a section side elevational view similar to FIG. 6 showing details of the wire feeder mounting assembly.

FIG. 12 is a perspective view showing details of a wire cable support attached to a side of the cart.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### DETAILED DESCRIPTION OF THE INVENTION

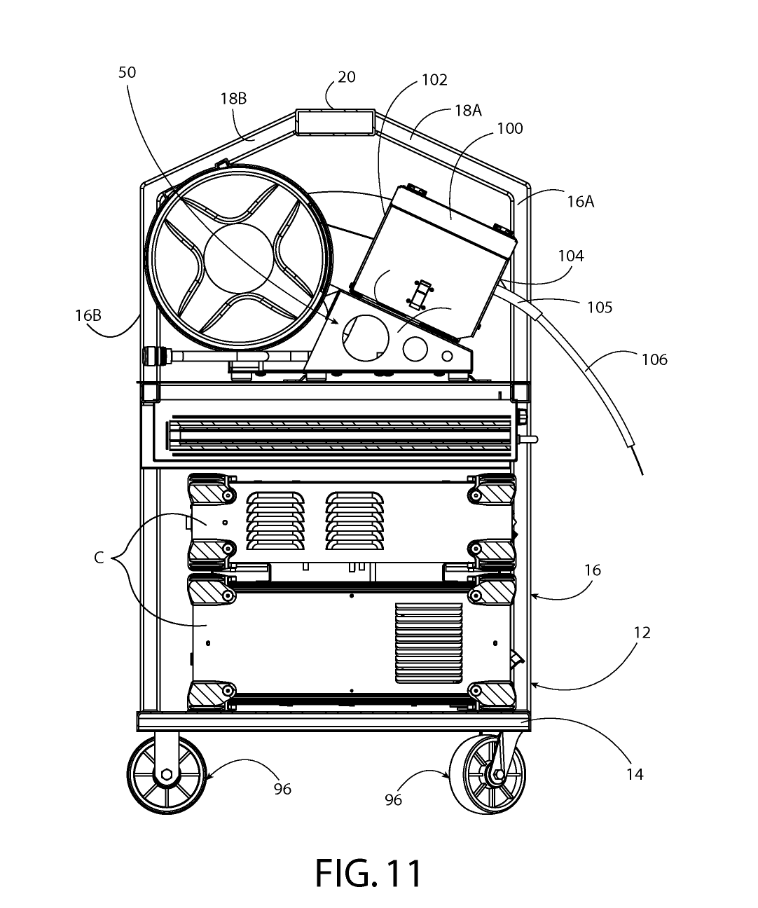

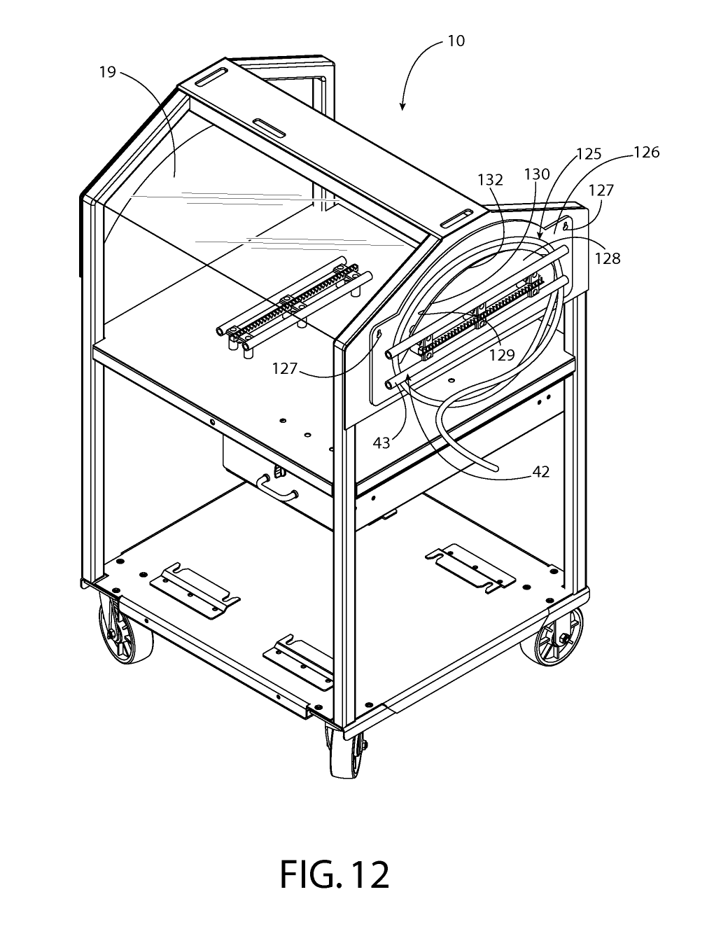

A welding cart according to the concepts of the invention is generally indicated by the number 10 in the accompanying drawings. Welding cart 10 includes a frame 12 adapted to support one or more welding components. Welding components include but are not limited to power supplies, welding controllers, wire feeders, welding tractors, welding consumables, and the like. Frame 12 includes a base 14 having plural supports 16 extending upward therefrom. In the example shown, frame includes a pair of upstanding side supports 16 each side support having a first post 16A and a second post 16B respectively located at the front and rear corner of the base 14. The front and rear posts 16A and 16B are connected at their upper extremities by and end 18. End 18 may have any shape suitable for connecting the first and second posts to each other including but not limited to a horizontal rail, a curved rail, angular rails that meet at a peak or other combinations thereof. In the example shown, a first angled rail 18A extends rearward and upward from first post 16A and a second angled rail 18B extends forward and upward from rear post 16B. The slope of ends 18 promotes run off when a cover 19 (FIG. 12) is attached thereto. Cover may be any member including but not limited to a tarp, a flat sheet or molded part. Cover 19 may be made from any material including but not limited to natural fiber material, paper and other pulp products, wood, fabrics (natural, synthetic, or combinations thereof), glass, ceramics, plastics, rubber materials, or other polymer based materials, metals and combinations thereof. In the example shown, a clear plastic panel is used to provide cover and visibility. Forward angled rail 18A and rearward rail 18B are connected by a cap piece 20 that extend horizontally between the side support 16 and spans the width of the cart 10. Cap piece 20 may have any shape of cross section including but not limited to a solid beam or rectangular tube as shown in FIG. 11.

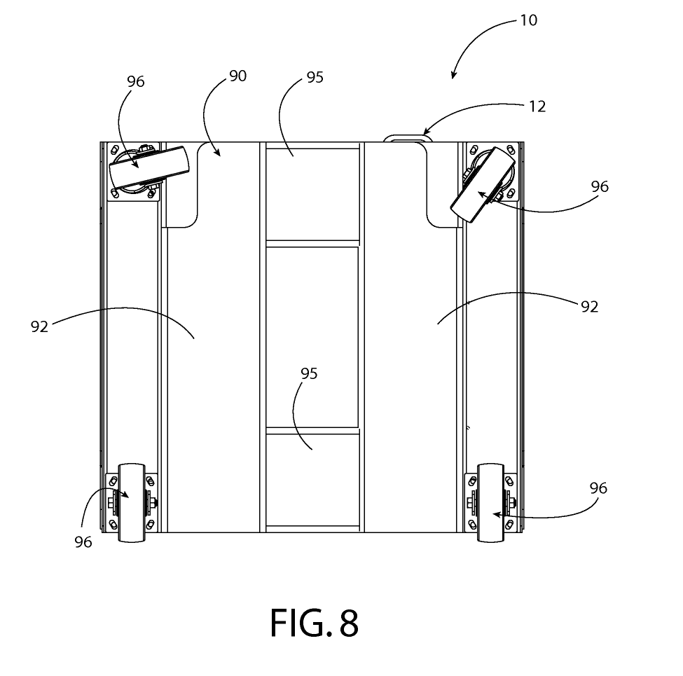

In accordance with another aspect of the invention, cap piece 20 may include one or more receivers 22 to which components may be attached. In the example shown, receiver 22 includes a slot formed in the cap piece. As best seen in FIG. 8, a slot is formed at each end of cap piece 20 to allow components to be hung near the sidewalls 16 of cart 10. Additional slots may be formed across the width of cap 20 to hang components such as a controller 23 over the cart 10. According to another aspect of the invention, a hanger 25 may be provided to facilitate lifting of the cart 10 with a crane or the like. In the example shown, hanger 25 includes a member 26 extending vertically from the cap 20 and welded thereto, where the member 26 defines an opening 27 adapted to receive a hook from a crane.

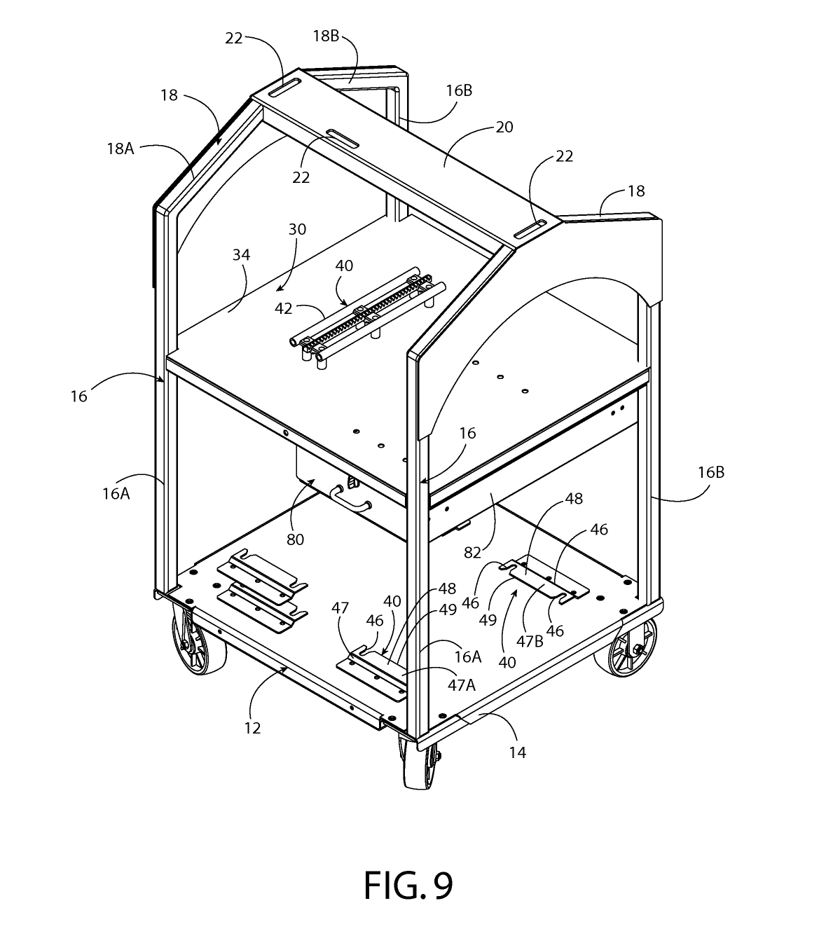

A shelf, generally indicated by the number 30 may be supported on the supports 16 and spaced upward from base 14 to support components in a spaced relationship. The shelf 30 may be supported on supports 16 in any manner including providing rails extending horizontally between the posts 16A and 16B on each side and between posts 16A at the front of the cart and between posts 16B at the rear of the cart to form a shelf frame 32 at the perimeter of the cart 10 on which the shelf is supported. Shelf 30 may be constructed of any type of material including but not limited to metals, plastics, or wood. As best shown in FIG. 9, attachment assemblies, generally indicated by the number 40 may be provided on the upper surface 34 of shelf 30 to facilitate attachments of various components to the shelf 30. Similar attachment assemblies may be provided on the upper surface 15 of base 14. The attachment assembly 40 may include but are not limited to standard clips, pins, posts, tie downs, or other fasteners that may be used to secure the components to the surfaces of the cart 10.

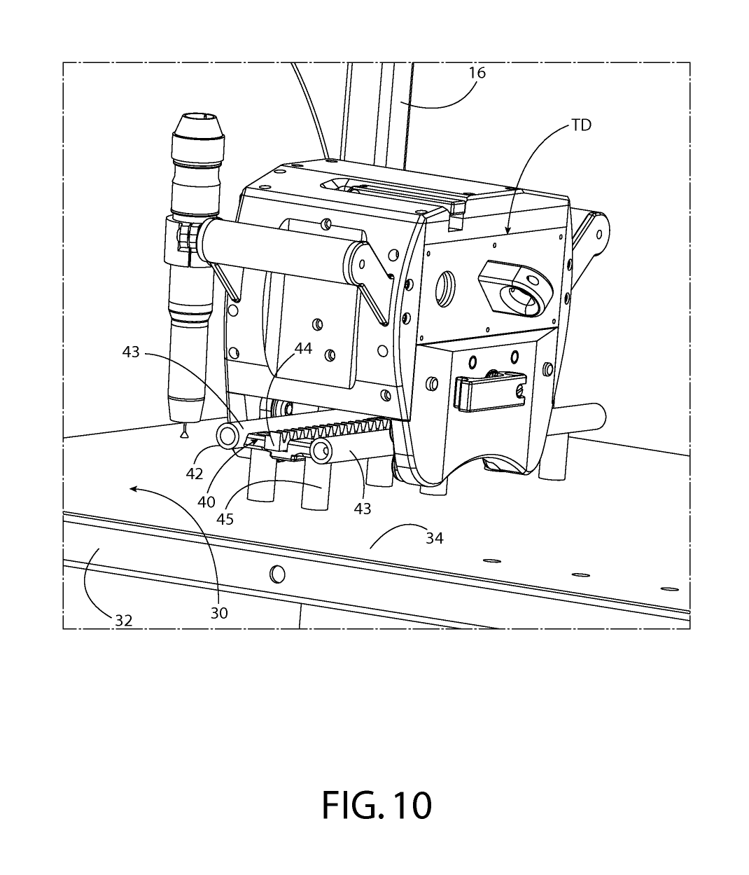

According to one aspect of the invention, shown best in FIG. 10, attachment assembly 40 includes a section of track 42 of a track driven welder TD would be attached to the upper surface 34 of shelf 30 to facilitate attachment of a tractor driven welder to that track 42. In particular, the section of track 42 includes a pair of tubular outer rails 43 spaced from each other by a framework that includes a central gear section 44. The clamping assemblies of the tractor driven welder TD, which includes bearings that grasp the rails 43 may be used to clamp the track driven welder TD to the cart 10. Alternatively, the clutch on the tractor driven welder TD may be engaged with the gear teeth 44 to further secure the track driven welder TD. As shown, the section of track 42 may be elevated from the top surface 34 of shelf 30 by one of more posts 45.

As best shown in FIG. 9, attachment assembly 40 may also include slotted receivers 46 that engage downwardly extending projections mounted on the components C. In the embodiment shown in FIG. 9, the slotted receivers 46 are provided on brackets 47 bolted to the base 14 of the cart 10. A first bracket 47A is provided at a forward end and a second bracket 47B is provided at a rearward end. The brackets 47A, 47B are spaced from each other an amount based on the size of the component. Each bracket includes an attachment portion that is fasted to the cart 10, for example to a portion of frame, the base, on the shelf A raised portion, such as for example, raised lip 48 extends upward from the surface to which the bracket is attached toward the component. Raised lip 48 may directly engage a portion of component to restrict movement of component relative to cart. Alternatively, as shown, a receiver 46 may be in raised lip to engage a projection on the component. In the example shown, slotted receivers, also referred to simply as slots, extend inward from an edge 49 of raised lip. The slots may be wider at the edge 49 of the lip and narrow as they extend inward. As shown slots 46 on first bracket and second bracket may open toward each other such that brackets 47 may be slid inward toward each other until projections on the components are within slots 46, and then brackets may be fastened to the base. The walls of the slots restrict lateral and longitudinal movement while the lip may restrict vertical movement to secure the component to the cart 10.

In accordance with another aspect of the invention, a wire feeder 100 is supported on the cart 10 at a downward extending angle. To that end, a mounting assembly, generally indicated by the number 50, is provided on frame 12 to raise a rearward end 102 of wire feeder 100 causing the forward end 104 of wire feeder 100 to slope downward toward the front of cart 10. The forward end 104 of wire feeder 100 includes a wire conduit 105 that extends forward from cart 10. As best shown in FIG. 11, due to the downward angle of wire feeder 100, the wire conduit extends forward and downward relative to the wire feeder at an angle 106 greater than 90°.

Mounting assembly 50 may include a mount 52 capable of supporting the rearward end 102 of wire feeder 100 above forward end 104 including but not limited to a projection at the rearward end or a sloped mounting surface 54 as shown. The mounting assembly 50 shown may also be removable from the cart 10 to allow the wire feeder to remain on the mounting assembly 50 and attach to a bench or other supporting surface when the wire feeder is not used on the cart 10. The mounting assembly 50, shown, includes a base 56 having plural feet 58 to support the mounting assembly 50 on a surface. A pair of side walls 60 extend upward from the base 56, where the upper edge 61 of the sidewalls 60 is sloped upward from a front edge 62 of base 56 toward the rear of the base 56. As shown the upper edge may also include a downwardly sloped portion 64 toward the rear of the mounting assembly 50 to provide clearance for mounting a larger spool 110 of welding wire. A first plate 71 may be attached to the upwardly sloped edges of side wall 60 and a second plate 72 may be attached at the downwardly sloped portion of side plate 62. To facilitate securing the mounting assembly 50 to the cart 10 or the bench or other supporting surface, fastening tabs 75 may extend downward and outward of the base 56 and be provided with one or more receivers through which screws or other fasteners pass to secure the mounting assembly 52 to a surface. In the example shown, mounting assembly 50 is secured to shelf 30.

In accordance with another aspect of the invention, a drawer generally indicated by the number 80 may be supported on the cart 10. In the example shown, drawer 80 is mounted beneath shelf 30 and supported by a pair of downwardly depending side frame members 82 extending from the shelf 30. Drawer 80 is slideably received on the side frame members 82. In the example shown, telescoping arms 84 are provided on each side frame member 82 to attach to the drawer 80 and allow the drawer to be slid outward from side frame members 82 and support components in the drawer 80. To facilitate operation, a handle 85 may be provided on a front face 86 of drawer 80. A latch or lock 87 may also be provided on the drawer to secure it in place during transport of the cart 10.

In accordance with another aspect of the invention, the cart 10 includes an undercarriage assembly generally indicated by the number 90. The undercarriage assembly 90 is attached to the base 14 of cart 10. Undercarriage assembly 90 includes a pair of channel members 92 that define channels 94 configured to receive the tines of a fork lift therein. In the example shown, channel members 92 have a U-shaped cross section with open sided channels 94 oriented such that the open side of the channel extends away from the center of the cart 10. The channels are spaced from each other by a pair of spacers 95 located at the front and rear of the cart 10 between channel members 92.

To make the cart 10 more mobile, a transport assembly 96 may be attached to the base 14 and extend downward therefrom. Transport assembly 96 may include but is not limited to any structure that improves the mobility of the cart including but not limited to wheels, rails, runners other rolling elements, track assemblies, and the like. According to another embodiment, transport assembly 96 includes a structure that facilitates movement or transport of the welding cart 10 by an external device, such as a fork lift or crane. To that end, transport assembly 96 may include structures that define fork lift tine receivers or an opening to which a cable may be attached including but not limited to the channel members 92 and hook 25 described above. As shown in the depicted example, transport assembly 96 may include combinations of various transport assemblies.

In the example shown, transport assembly 96 includes wheels that extend downward from the base of the cart 10. The wheels are used to increase the mobility of the cart 10 on a supporting surface S. The wheels may be rotatably mounted in any fashion. Pairs of wheels may be mounted on a common axle, or, as shown, one or more wheels may be rotatably supported on a caster. Caster generally includes a pair of downward extending tabs located on either side of each wheel with an axle extending between the tabs and through the hub of the wheel to rotatably support the wheel thereon. Caster may include a cross piece that joins the tabs above the wheel to facilitate mounting the caster to the base of the cart 10. On or more of the casters may be rotatably mounted to the cart 10 to make the cart easier to move and steer. As shown, the rear castors may be fixedly mounted to the base of the cart while the forward casters include bearing elements B that allow the forward caster to rotate about a vertical axis to steer the cart 10.

According to another aspect of the invention, a clearance 97 is defined between the lower surface 98 of the channel members 92 and the bottom 99 of castor 96. The clearance 97 is less than 4 inches to allow palletizing of the cart 10 with standard 4×4 blocks as show in FIG. 14. The palletizing of the cart 10 raises the transport assembly 96 off the supporting surface to immobilize the cart 10. In the example shown, the wheels of the casters are raised so that the cart 10 will not roll on the casters. It will be appreciated that blocks or other supports having a height of four inches or more may be used to palletize the cart 10 to the same effect. The transport assembly 96 may be disengaged from the supporting surface in this manner during transport or other instance where it is desirable to immobilize the cart 10.

In accordance with another aspect of the invention, the cart 10 has a width W less than the width of a standard door. For example, a width less than 36 inches is as suitable. In the example shown, the width W of the cart 10 is 30 inches. The various members making up the cart 10 and the shape of the cart 10 shown is just one example and the shapes may be varied without limiting the function of the cart. As shown, various sheet like members may be attached to the frame 12 to change the appearance of the cart 10 or removable sheet members may be used to cover areas of the cart 10 on a permanent or temporary basis. For example, in accordance with another aspect of the invention, a cover sheet may be attached to the cart when the cart is being transported on when used in an outdoor application. In the example shown, a first cover sheet may be attached to the angle rails 18A and a second cover sheet may be attached to the rear angled rails 18B to form a sloped cover over the cart 10. The slope of the cover may facilitate run off from the welding environment or water or other contaminants that may fall onto the cart 10. It will be understood that while the sloped configuration is provided by the depicted frame 12, this configuration is not limiting in terms of performing these functions. Curved surfaces may be used to the same effect and steeper slopes for a pitched section with a single point of intersection between the forward and rearward surfaces may be used. Still as a further alternative, the rear posts of the cart may be higher than the forward posts of the cart with a single sloped or curved section extending upward and rearward from the forward posts to the rear posts or vice versa depending on the desired look of the cart.

With reference to FIG. 12, in accordance with another aspect of the invention, a welding conduit bracket, generally indicated by the number 125 may be provided on cart 10. Welding bracket 125 includes a backing plate 126 that may be hung on cart 10 at receivers 127 formed in the backing plate 126. Alternatively, the backing plate 126 will be fastened to the cart with a suitable fastener including but not limited to mechanical fasteners such as screws or bolts, an adhesive, of a weld. A curved conduit support 130 extends outwardly from backing plate 126. As shown, the conduit support has a arch shape extending downward on each side from the center to facilitate coiling of a welding conduit WC there on. A front plate 120A is spaced from backing plate 126 by conduit support 130 and extends upward relative to the top surface 132 of conduit support 130 to form a lip 129 that helps retain the conduit.

As an option, an attachment assembly 48 may be mounted to the front face 128 to allow attachment of a component to the conduit support assembly 125. In the example shown, the attachment assembly includes a section of track having rails 43 that extend outward beyond the front face 128 in the lateral direction to further retain the welding conduit WC coiled thereon.

Specific embodiments of an innovation are disclosed herein. One of ordinary skill in the art will readily recognize that the innovation may have other applications in other environments. In fact, many embodiments and implementations are possible. The following claims are in no way intended to limit the scope of the subject innovation to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the subject innovation has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (e.g., enclosures, sides, components, assemblies, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application. Although certain embodiments have been shown and described, it is understood that equivalents and modifications falling within the scope of the appended claims will occur to others who are skilled in the art upon the reading and understanding of this specification.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A welding cart comprising:
a frame; a mounting assembly supported on the frame, the mounting assembly on which a wire feeder is supported, the mounting assembly including a mount configured to raise a first end of the wire feeder to support the wire feeder at an angle, where a wire conduit extending from the wire feeder extends from a lower end of the wire feeder.

2. The welding cart of claim 1, wherein the mount has a sloped mounting surface adapted to support the wire feeder.

3. The welding cart of claim 1, wherein the mounting surface angles the wire feeder downward such that the wire conduit extends from the wire feeder at an angle greater than 90°.

4. The welding cart of claim 1, wherein the frame includes a base, plural supports extending upward from the base, a shelf mounted on the supports and spaced upward from the base, wherein the mounting surface is supported on the shelf

5. The welding cart of claim 4, wherein an attachment assembly is supported on the shelf to releasably attach a component to the shelf.

6. The welding cart of claim 5, wherein the attachment assembly includes a section of track for a track driven welder.

7. The welding cart of claim 1, wherein the frame includes an attachment assembly thereon adapted to releasably attach a component to the cart, the attachment assembly including a first bracket and a second bracket placed in spaced relation to each other, each bracket including at least one receiver adapted to engage a portion of the component to restrict vertical movement of the component relative to the bracket, the first bracket and second bracket being attachable to the frame with the portion of the component engaged within the receiver to restrict lateral and longitudinal movement of the component relative to the frame.

8. The welding cart of claim 7, wherein each bracket includes a raised lip, wherein the at least one receiver includes a slot formed in a forward edge of the raised lip, wherein the first bracket and second bracket are attached to the frame such that the slot formed in the raised lip of the first bracket opens toward the slot formed in the raised lip of the second bracket.

9. The welding cart of claim 1, wherein the frame includes a base, a transport assembly extending downward from the base to movably support the frame.

10. The welding cart of claim 9, wherein the transport assembly includes plural wheels.

11. The welding cart of claim 10, wherein at least one of the wheels is mounted on a caster, the caster being rotatable about a vertical axis to steer the cart.

12. The welding cart of claim 1 wherein the frame includes a pair of side supports laterally spaced from each other, each side support having an end extending upward of the mount, wherein the ends include at least one surface having a slope that promotes runoff when a cover is attached to the ends.

13. The welding cart of claim 1, wherein the frame includes a pair of side supports laterally spaced from each other and a cap piece extending laterally to connect a first of the side supports to the second of the side supports, wherein the cap piece includes a receiver to which a component is attached.

14. The welding cart of claim 13, wherein the receiver includes a slot defined in the cap piece.

15. The welding cart of claim 1 further comprising a drawer supported on the frame.

16. The welding cart of claim 1 further comprising an under carriage assembly defining a pair of channels, each channel adapted to receive a tine of a fork lift.

17. The welding cart of claim 16 wherein the frame includes a base, wherein the under carriage assembly is located beneath the base; and
a transport assembly extending downward from the base and below the under carriage assembly to define a clearance between a lower surface of the under carriage assembly and the bottom of the transport assembly, wherein the clearance is less than 4 inches.

18. The welding cart of claim 17 wherein the under carriage assembly includes channel members defining the channels, wherein the channel members extend longitudinally along the base and are spaced inward from the transport assembly.

19. The welding cart of claim 1 further comprising a welding conduit support attached to the frame, the welding conduit support including an outwardly extending arched surface and a forward face extending above the arched surface to form a lip.

20. A welding cart comprising:
a frame having a base, plural supports extending outward from the base;
a shelf supported on the supports and spaced upward from the base;
a mounting surface supported on the shelf and adapted to support a wire feeder thereon, the mounting surface extending upward as it extends rearward to support the wire feeder at an angle that slopes downward toward a front of the shelf, wherein the wire feeder includes a wire feed conduit that extends from a lower end of the wire feeder and wherein the conduit drapes downward from the wire feeder forming a bend having an angle greater than 90°.
